(19) United States
(12) Patent Application Publication
(10) Pub. No.: US 2002/0042749 A1
(43) Pub. Date: Apr. 11, 2002

(54) Discount sale management apparatus and method thereof

(76) Inventors: Takashi Yugami, Aomori (JP); Tetsuo Nakata, Aomori (JP); Mitsumasa Nagase, Aomori (JP)

Correspondence Address: STAAS & HALSEY LLP, 700 11TH STREET, NW, SUITE 500, WASHINGTON, DC, 20001, US

(21) Appl. No.: 09/812,814

(22) Filed: Mar. 21, 2001

(30) Foreign Application Priority Data
Oct. 6, 2000 (JP) 2000-307563

(51) Int. Cl. G06F 17/60

(52) U.S. Cl. 705/26

(57) ABSTRACT

A discount sale management apparatus has a discount rate registration unit, a selling price setting unit, a product information and price provision unit, and an order receipt unit. The discount rate registration unit receives and registers discount information about product discount sale from a seller over a network N. The selling price setting unit counts a sales quantity; while the sales quantity is less than a planned discount sales quantity, sets a discount price produced by discount from an original price as a selling price, based on the discount information; and after the sales quantity reaches the planned discount sales quantity, sets the original price as the selling price. The product information and price provision unit provides a selling price set by the selling price setting unit to a purchaser over the network. The order receipt unit receives purchase orders from the purchaser.

### BACKGROUND OF THE INVENTION

1. Field of the Invention

The present invention relates to a system that manages product sale, and more particularly to a sale management system that sells products at a discount under predetermined conditions.

2. Description of the Related Art

Factors of setting product prices include costs in manufacturing and production, fees for distribution and sales, and profits changing depending on the speculation of those concerned in manufacturing and production, and distribution and sales. In contrast to sales at an original price based on the above described factors, to promote sale for the purpose of increasing a sales quantity, etc., discount sale for selling at a discount from an original price, and limited sale limiting the number of products to be sold are sometimes performed.

For example, in supermarkets and the like, limited-time discount sale and discount sale immediately before the closing of a store are performed. These discount sales are performed to attract sales prospects or to minimize loss by selling a specific product which can not be kept in stock.

Limited sale is performed in, e.g., a car shop, etc. The limited sale is intended to spur the purchasers' incentive to purchase by giving the product a premium image, and providing purchasers with the sense of being relatively inexpensive, or the sense of haste that delayed purchase would make acquisition difficult.

However, the prices of works, e.g. illustrations, computer graphics, and pictures, and goods such as collector's items often depend greatly on the social positions and evaluation of product producers, and the preference of purchasers rather than on costs in manufacturing and production, and fees for distribution and sales.

Therefore, the prices of works produced by producers not established in their social positions and evaluation, such as newcomers depend more greatly on the preference of purchasers than those of works of famous producers. Consequently, there has been a problem in that even products having common and reasonable prices may be wholly unsaleable because of the lack of enough power to spur the incentive to purchase if they do not satisfy the preference of purchasers.

In such a case, there has also been a problem in that, even if purchasers had a wish to buy them if they were cheaper, since there has been no opportunity for the purchasers to demand a discount on the product prices, it has been impossible to have sellers recognize that the products would sell they were discounted.

### SUMMARY OF THE INVENTION

The problem to be solved by the present invention is to enable discount sale management so as to perform sale in line with the speculation of both purchasers and sellers. The above description does not mean that the present invention limits the products to be sold to literary works.

The present invention is effective for use particularly when products are to be sold at a discount.

According to an embodiment of the present invention, a discount sale management apparatus that manages a selling price comprises a selling price setting unit counting a sales quantity, while the sales quantity is less than a predetermined quantity, setting a discount price as a selling price, the discount price being a price produced by discount from an original price, and after the sales quantity becomes equal to or greater than the predetermined quantity, setting the original price as the selling price; and a price provision unit providing the set selling price. After selling a predetermined quantity of a product at a discount and increasing the popularity of the product, the discount sale management apparatus sells the product at an original price. Thereby it becomes possible to compensate for a loss resulting from the discount sale. This leads to promoting the sale of the product.

In the above described configuration, the selling price setting unit may change a discount price relative to time, or may lower them with the elapse of time. For example, if product sales are so sluggish that a sales quantity does not reach a desired quantity, by lowering the discount price to a salable price, it becomes possible to know at what price purchasers purchase the product. In the above configuration, with a minimum selling price assigned to a discount price, even after the discount price is lowered with the elapse of time so that a selling price reaches the minimum discount price, if a sales quantity does not reach the desired quantity, the selling price setting unit may hold the minimum discount price as long as a sales quantity is less than the desired quantity.

In the above described configuration, the discount sale management apparatus may further comprise a price provision unit that provides a schedule of change of the discount price, and an order receipt unit that accepts, from a purchaser, a purchase reservation specifying a desired purchase price, a purchase reservation time of the purchase reservation is set when the selling price reaches the desired purchase. Thereby, the purchaser can notify a seller of a desired price at which the purchaser wants to purchase the product.

In the above described configuration, the discount sale management apparatus may further comprise a reservation allocation processing unit that, when the order receipt unit accepts a purchase reservation and the selling price reaches the desired purchase price, allocates the product to the purchase reservation if a sales quantity is less than the predetermined quantity. The reservation allocation processing unit may cancel the purchase reservation if the sales quantity is equal to or greater than the predetermined quantity. This enables the purchaser to notify the seller of a desired purchase price and wait until the purchase reservation time and at the time, if the sales quantity is less than the predetermined quantity, that is, the product to be sold at a discount remains, the purchaser can purchase the product at the desired purchase price. The seller can promote the sale of product whose sales are sluggish. Conversely, sales go well as the seller expects, and if a sales quantity becomes equal to or greater than the predetermined quantity, by canceling the purchase reservation, the seller can prevent a loss resulting from extra discount sale. Buyers cannot purchase the product at their desired prices but can purchase it at the original price before the discount.

According to another embodiment of the present invention, a discount sale management method for managing a selling price comprises the steps of: counting a sales quantity; while the sales quantity is less than a predetermined quantity, setting a discount price as a selling price, the discount price being a price produced by a discount from an original price; and after the sales quantity becomes equal to or greater than the predetermined quantity, setting the original price as the selling price. The above described problem can also be solved by this method.

The above described problem can also be solved by loading programs for having a computer perform the same control as the functions performed by the above described configuration into the computer from a computer-readable recording medium in which the programs are recorded, and executing the programs.

### BRIEF DESCRIPTION OF THE DRAWINGS

The features and advantages of the present invention will be more clearly appreciated from the following description taken in conjunction with the accompanying drawings in which like elements are denoted by like reference numerals and in which:

FIG. 1 is a block diagram of a discount sale management system according to the present embodiment;

FIG. 2 is a diagram showing one example of a data structure of a discount table;

FIG. 3 is a diagram showing one example of a data structure of a product master;

FIG. 4 is a diagram showing one example of a data structure of a reservation table;

FIG. 5 is a diagram showing one example of a data structure of a purchase information file;

FIG. 6 is a diagram showing data transition in the case of immediate purchase;

FIG. 7 is a diagram showing data transition in the case of reserved purchase;

FIG. 8 is a flowchart showing discount information registration processing;

FIG. 9 is a diagram showing one example of a discount rate registration screen;

FIG. 10 is a flowchart showing product information and price presentation processing;

FIG. 11 is a diagram showing one example of a product information and price provision screen;

FIG. 12 is a flowchart showing a selling price setting processing;

FIG. 13 is a diagram for explaining a selling price to be set;

FIG. 14 is a flowchart showing order receipt processing;

FIG. 15 is a flowchart showing a reservation allocation processing (1);

FIG. 16 is a flowchart showing reservation allocation processing (2);

FIG. 17 is a block diagram of an information processing apparatus; and

FIG. 18 is a diagram for explaining recording media capable of supplying programs and data to a computer, and transmission signals.

### DESCRIPTION OF THE PREFERRED EMBODIMENTS

Hereinafter, embodiments of the present invention will be described with reference to the accompanying drawings. Identical apparatuses are identified by identical reference numerals.

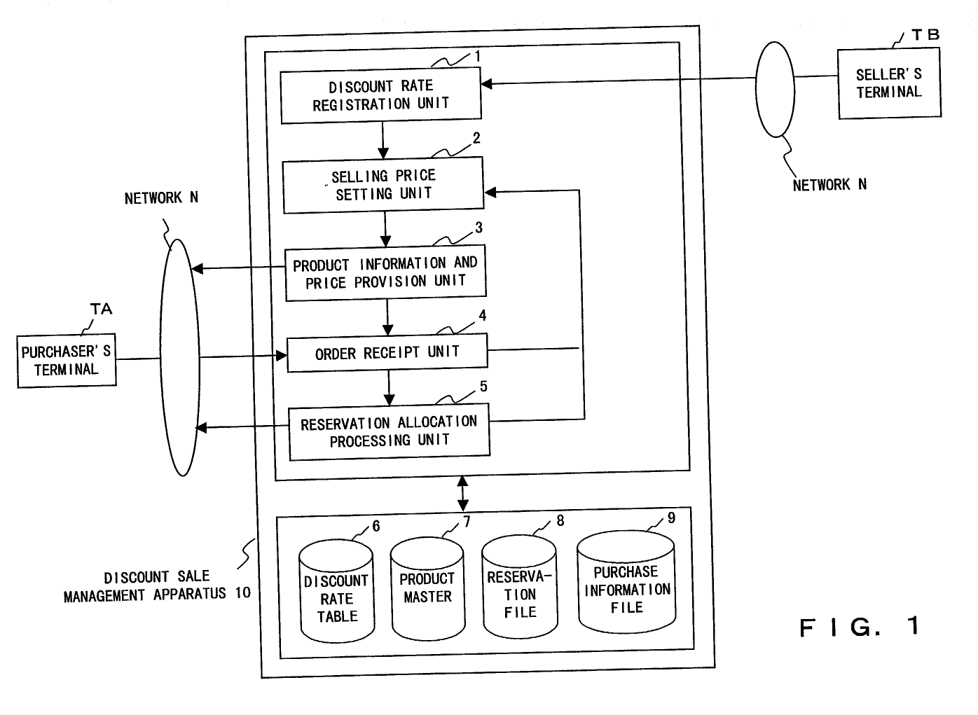

FIG. 1 shows the configuration of a discount sale management system according to an embodiment of the present invention. As shown in FIG. 1, a purchaser's terminal TA, a seller's terminal TB, and a discount sale management apparatus 10 are connected over a network N. The network N may be either a single network or a combination of plural networks. The network N may be a WAN (Wide Area Network) such as the Internet, telephone line networks and wireless networks and a LAN (Local Area Network).

The terminals TA and TB may be, e.g., a desktop information terminal and a portable information terminal such as portable telephone and portable computer. If the terminals TA and TB are portable information terminals, character information services used for portable mobile terminals, e.g., i mode (registered trademark of NTT DoCoMo) can be used. However, this is only an example and does not limit the present invention. The purchaser and the seller may exchange given information with the discount sale management apparatus 10 over telephone, facsimile, or the like.

The purchaser obtains product information and product prices from the discount sale management apparatus 10 through the terminal TA and sends a product order to the discount sale management apparatus 10. The purchaser may purchase a product at a selling price at that point or reserve purchase at a desired price. The seller, through the terminal TB, sends product information about products to be sold and discount information for managing products to be sold at discount prices to the discount sale management apparatus 10.

The discount sale management apparatus 10 manages product sale and sells products at a discount in specified cases. The discount sale management apparatus 10 comprises a discount rate registration unit 1, a selling price setting unit 2, a product information and price provision unit 3, an order receipt unit 4, a reservation allocation processing unit 5, a discount rate table 6, a product master 7, a reservation file 8, and a purchase information file 9.

The discount rate registration unit 1 receives discount information about products to be sold at discount prices from the seller and registers it in the discount sale management apparatus 10, and stores the received discount information in the discount rate table 6.

The selling price setting unit 2 sets the selling prices of products, based on discount information and sales quantity (sales quantity, a number of sold products) stored in the discount rate table 6. The selling price set by the selling price setting unit 2 may differ depending on the purchase date. The product information and price provision unit 3 provides product information obtained in advance from the seller, etc., and selling prices set by the selling price setting unit 2 to the purchaser. The order receipt unit 4 receives product orders from the purchaser. The order receipt unit 4 receives reserved purchase orders and immediate purchase orders, and stores them in the reservation file 8 or the purchase information file 9, respectively.

The reservation allocation processing unit 5 allocates products to reservations, based on the quantity of the reserved products and reservation date scheduled for purchase of the reserved products stored in the reservation file 8, and discount quantity and product sales quantity stored in the discount rate table 6. To be more specific, the reservation allocation processing unit 5, if a sales quantity is less than a specified quantity of products to be sold at a discount (discount quantity) when a reservation date is reached, sells the products at a reserved selling price. Otherwise, purchasers who made reservations are notified that reserved purchase failed.

Hereinafter, the data structures of tables and files will be described with reference to the accompanying drawings. In the drawings, data items (data names), data attributes, data lengths, and data actually stored are exemplified.

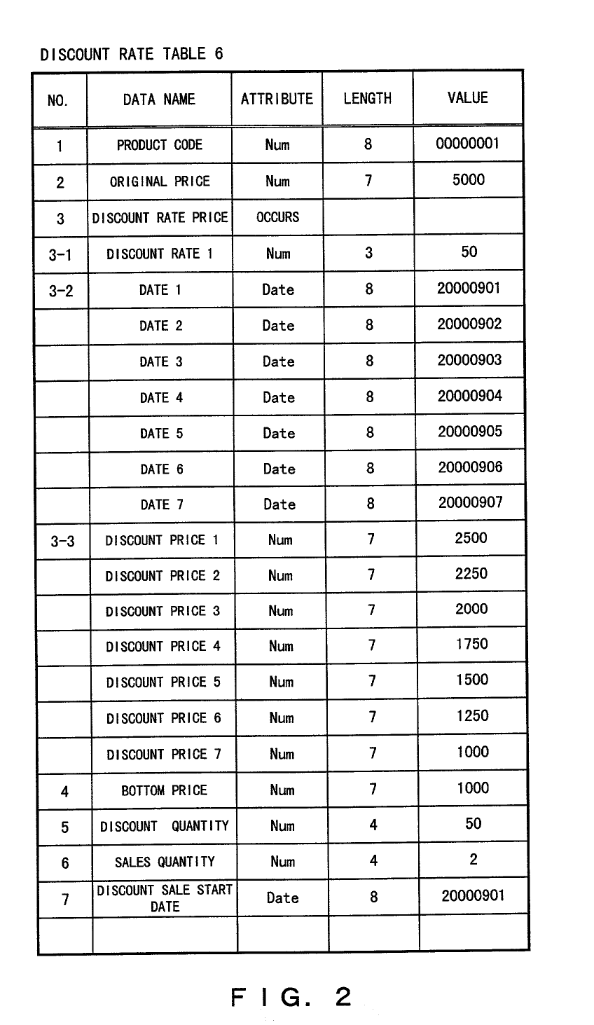

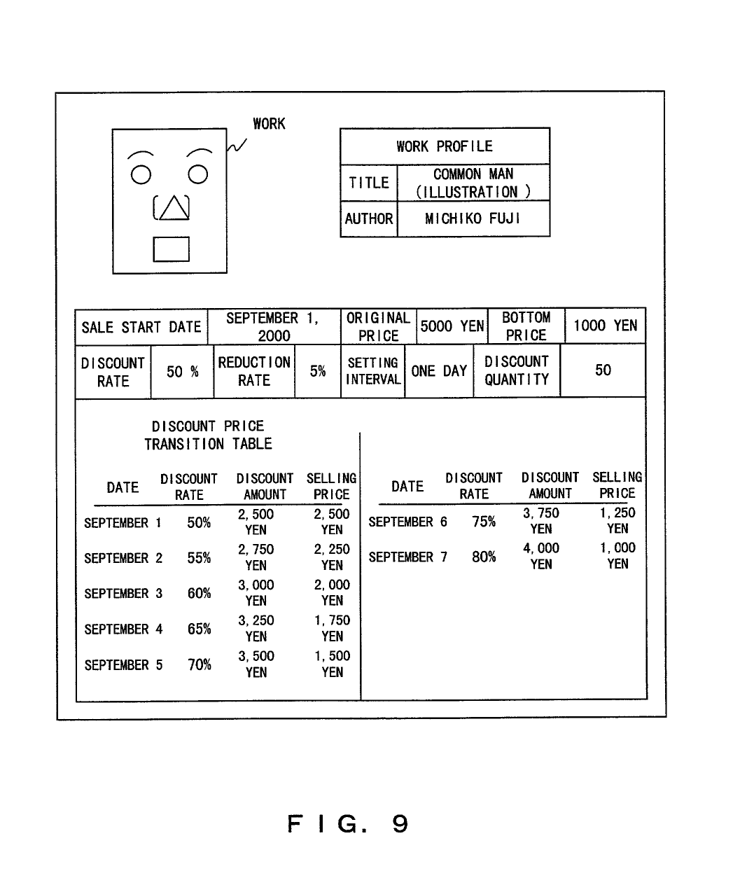

FIG. 2 shows an example of the data structure of the discount rate table 6. The discount rate table 6 stores discount information, which is information about discount sale. To be more specific, discount information for each of products sold at a discount, includes a product code for identifying the product, an original price, which is a selling price before the product is discounted, a discount price transition table which indicates a discount price according to date, a bottom price as the lowest discount price, a discount quantity, which is the quantity of the product to be sold at a discount, and a sales quantity. An example of FIG. 2 shows information stored when information as shown in FIG. 9 described later is inputted at discount rate registration. The contents of the discount rate table 8 are stored by the discount rate registration unit 1, based on discount information from the seller.

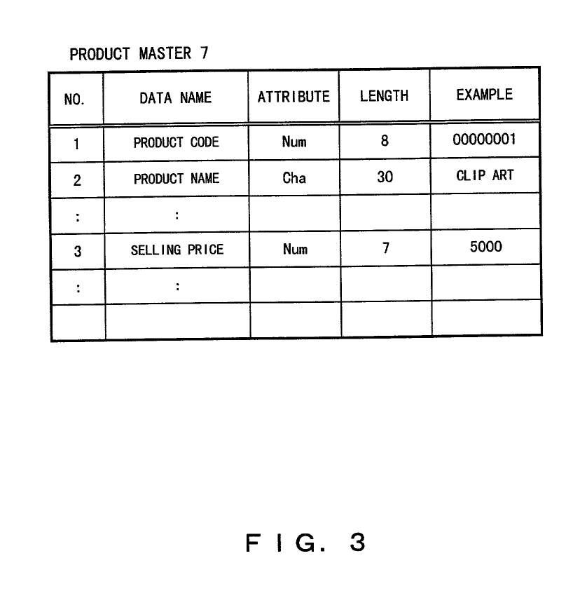

FIG. 3 shows an example of the data structure of the product master 7. The product master 7 stores product information, which is information about products. To be more specific, product information for each product, includes a product code, a product name, and a selling price. A selling price of the product master 7 corresponds to an original price of the discount rate table 6. The example of FIG. 3 shows the case that the product name of a product having a product code of 00000001 is cliunit and its selling price is 5000 yen. The contents of the product master 7 are stored when product sale from the seller is accepted.

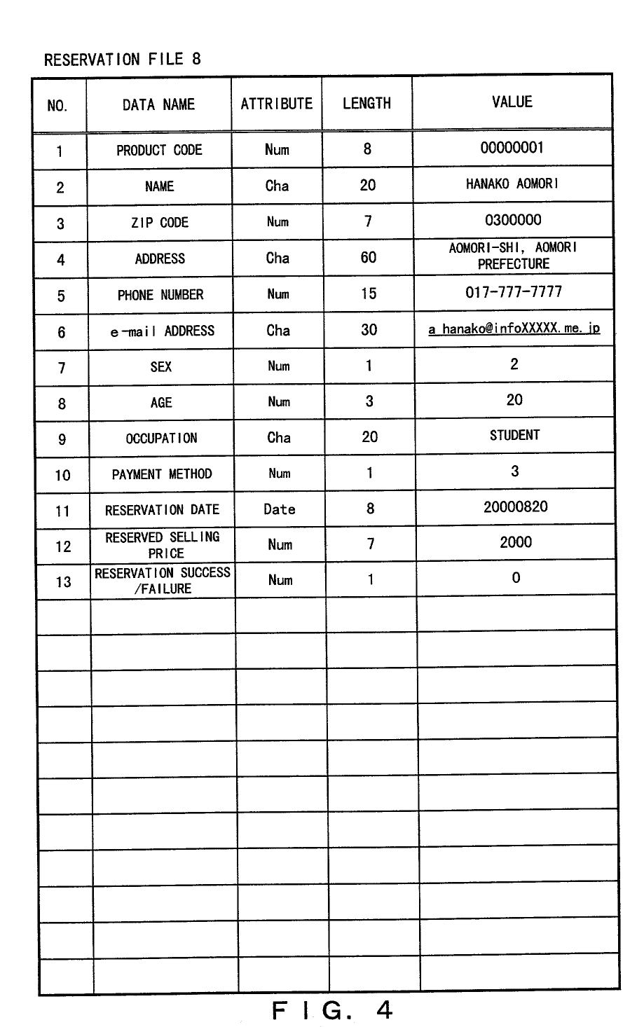

FIG. 4 shows an example of the data structure of the reservation file 8. The reservation file 8 stores reservation information, which is information about purchase reservations for products. To be more specific, reservation information for each reservation, includes the product code of a reserved product, personal information of a person making reservation for purchase, such as the name of the person, ZIP code, address, telephone number, electronic mail address, sex, age, occupation, and payment method, a reservation date at which the product is scheduled for purchase by reservation, a reserved selling price at which to purchase the product, and reservation success/failure flag. The example of FIG. 4 shows the case that a product having a product code of 00000001 is reserved by Hanako Aomori for purchase at a reserved selling price of 2000 yen and at a reservation date of Aug. 20, 2000. Information other than reservation success/failure flag is stored by the order receipt unit 4, based on information from the purchaser at reservation acceptance. The reservation success/failure flag is stored based on the result of the reservation allocation processing unit 5 judging whether allocation succeeds or fails when a reservation date is reached.

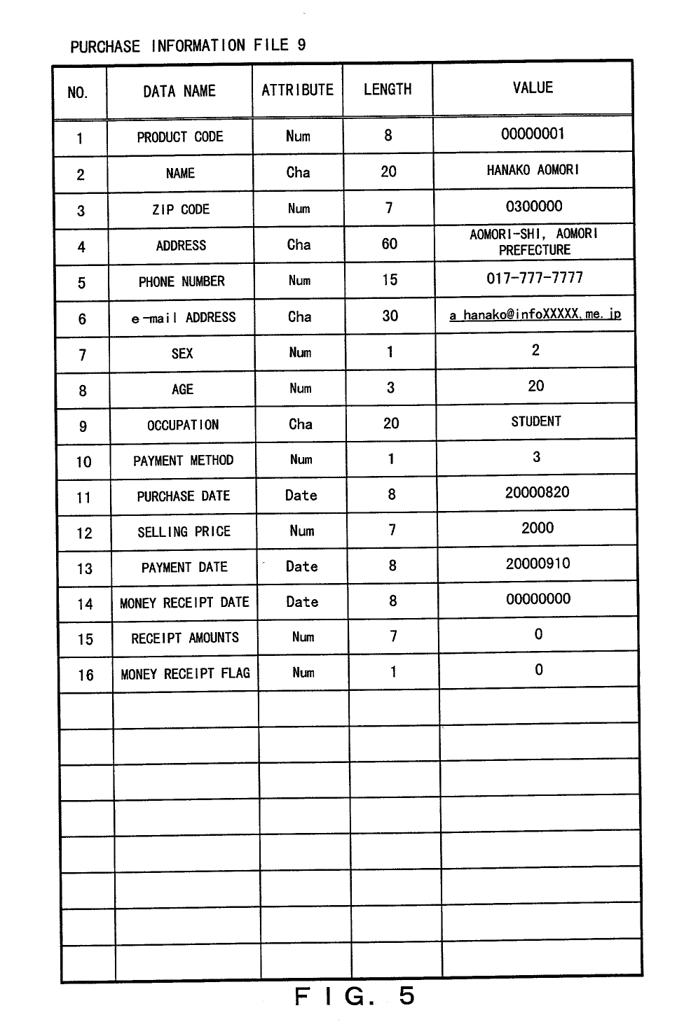

FIG. 5 shows an example of the data structure of the purchase information file 9. The purchase information file 9 stores information similar to that of the reservation file 8 for every purchase. Different points are that a purchase date is stored instead of a reservation date, and instead of a reservation success/failure flag, a payment expiration date on which a selling price is to be paid, and information about confirmation of money receipt is stored. Information about confirmation of money receipt includes money receipt date, receipt amounts, and a money receipt flag and is stored when money receipt is confirmed. Other information is stored by the order receipt unit 4, based on information from the purchaser. Or it is stored by the reservation allocation processing unit 5 at reservation allocation, based on reservation information.

The discount sale management system receives, from the seller, information used when products are sold at a discount, and sells the products to the purchaser at a discount, based on the received information. In discount sale, the discount sale management system provides current prices and planned price transition to the purchaser. The purchaser can purchase product at current selling price (hereinafter referred to as immediate purchase) or at a date (reservation date) at whicha selling price reaches a desired purchase price (reserved selling price), after making reservation taking price transition in discount sale into account (hereinafter referred to as reserved purchase). For reserved purchase, the discount sale management system allocates reservation if the sales quantity does not reach the discount quantity.

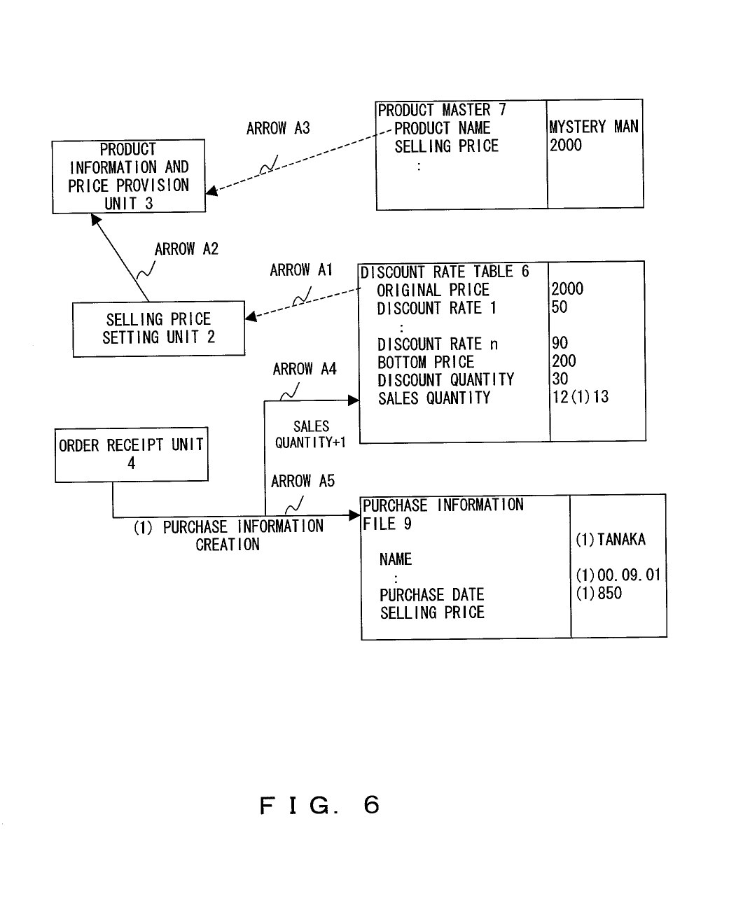

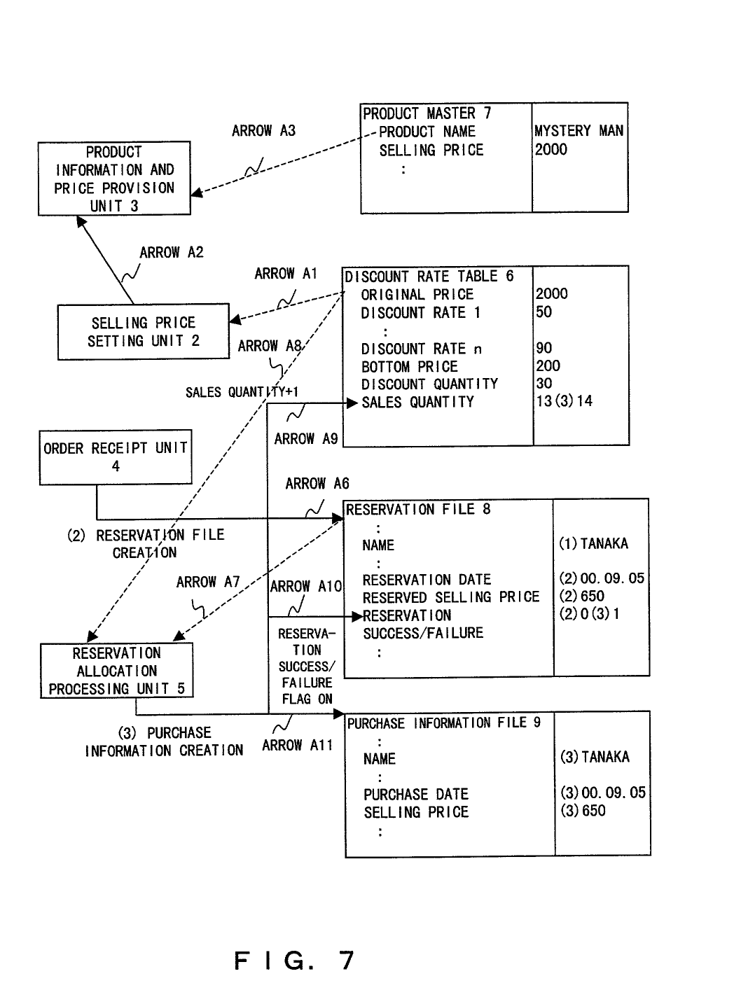

Hereinafter, data transition in this system will be described using FIGS. 6 and 7. In FIGS. 6 and 7, obtaining data from a database is indicated by an arrow of dashed line, and storing data in the database or updating data stored in the database is indicated by an arrow of solid line. First, immediate purchase will be described using FIG. 6. The discount rate registration unit 1 receives discount information from the seller and stores it in the discount rate table 6. The selling price setting unit 2 sets a current selling price and future price transition, based on discount information stored in the discount rate table 6 (an arrow A1). The product information and price provision unit 3 provides the current selling price and future price transition (an arrow A2) set by the selling price setting unit 2 and product information obtained from the product master 7 to the purchaser.

On receiving a immediate purchase order from the purchaser, the order receipt unit 4 creates purchase information based on the received order (an arrow A5), and stores it in the purchase information file 9. The order receipt unit 4 increments by one the sales quantity of a purchased product, stored in the discount rate table 6.

Next, data transition in reserved purchase will be described using FIG. 7. As in immediate purchase, the selling price setting unit 2 sets a selling price, and the product information and price provision unit 3 provides a calculated selling price and product information to the purchaser (arrows A1, A2, and A3). On receiving reserved purchase, the order receipt unit 4 creates reservation information about a reserved product and stores it in the reservation file 8 (an arrow A6). The reservation allocation processing unit 5 refers to the reservation file 8 and obtains the reservation information that a current date is a reservation date (an arrow A7). The reservation allocation processing unit 5 refers to the discount rate table 6 and obtains the discount quantity and sales quantity of the reserved product (an arrow A8).

The reservation allocation processing unit 5 judges whether the product can be allocated to a reservation, based on the discount quantity and the sales quantity. As a result of the judgment, if the product can be allocated to the reservation, the reservation allocation processing unit 5 increments by one the sales quantity of the purchased product stored in the discount rate table 6 (an arrow A9), turns on the reservation success/failure flag indicative of purchase success (an arrow A10), creates purchase information based on the reservation information (an arrow A11), and stores it in the purchase information file 9.

Hereinafter, processing performed in the discount sale management system will be described in detail with reference to the accompanying drawings. Although the following description assumes that the purchaser and the seller access the discount sale management system using the terminals TA and TB, respectively, to send and receive information. A GUI (Graphic User Interface) is employed as a user interface at the terminals, the present invention is not limited to this.

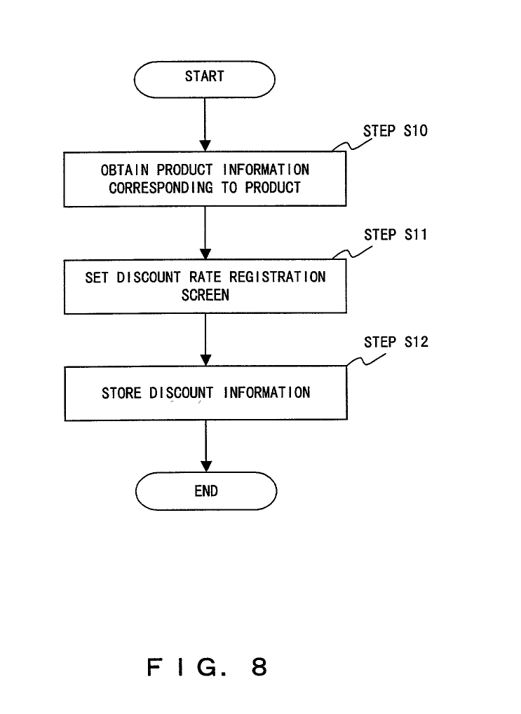

Using FIG. 8, a description will be made of how the discount rate registration unit 1 of the discount sale management apparatus 10 registers discount information in the discount rate table 6. First, the discount rate registration unit 1 receives the product code of a product to be sold at a discount from the seller, and obtains product information by referring to the product master 7 using the product code (step S10) . An example of product information to be obtained is the image, title, and author name of the product. Next, the discount rate registration unit 1 uses the obtained product information to set a discount rate registration screen on which discount information about the product is registered, and output it to the terminal TB of the seller (step S11). Next, the discount rate registration unit 1 of the discount sale management apparatus 10 stores received discount information in the discount rate table 6 (Step S12).

FIG. 9 shows an example of the discount rate registration screen. In FIG. 9, the image of a product (work) specified by the seller is displayed at the upper left portion of the screen, and the title and author of the product are displayed at the upper right. The seller can confirm the product by the display. The seller enters discount information according to instructions of the screen and sends it to the discount sale management apparatus 10. The discount information includes at least discount sale start date, original price, discount quantity (number of units sold at a discount), and discount rate.

To change the price depending on date, the seller may enter further a reduction rate and a setting interval. In this case, the discount sale management apparatus 10 calculates daily prices based on entered information and sets them in a discount price transition table as shown in the discount rate registration screen. The seller confirms the prices set in the discount price transition table, and if the prices are satisfactory, sends the contents of the discount price transition table to the discount sale management apparatus 10. Alternatively, instead of a reduction rate and setting interval, the seller may directly enter dates and prices to the discount price transition table and send the entered information to the discount sale management apparatus 10. Data in the discount price transition table are stored in the discount rate table 6. In this drawing, discount sale start date is Sep. 1, 2000; original price, 5000 yen; discount quantity, 50; discount rate, 50%; and reduction rate is 5% every setting interval (one day). However, a price cannot lower below a bottom price 1000 yen.

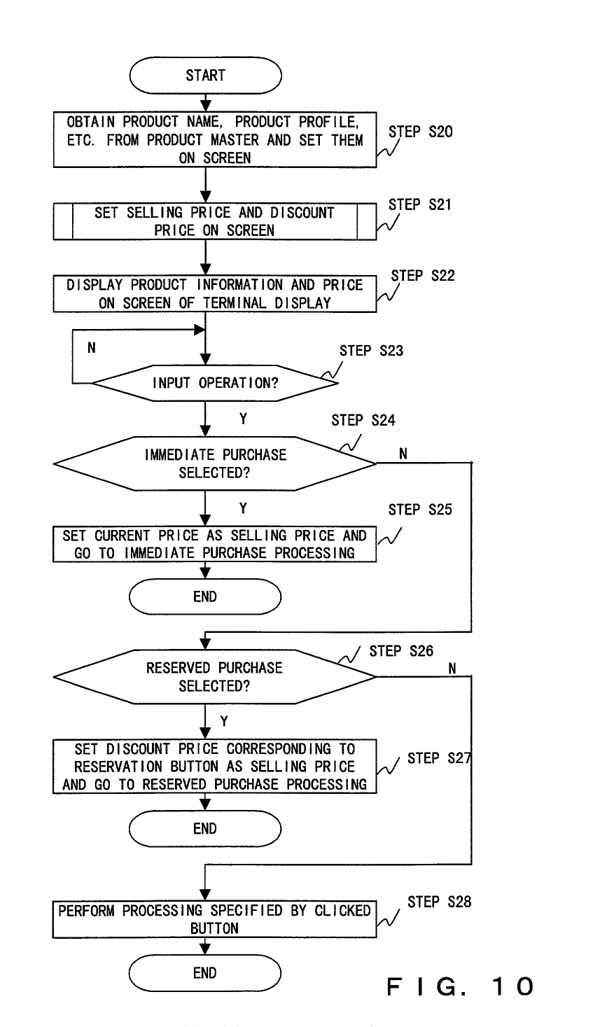

Next, using FIG. 10, a description will be made of processing performed by the product information and price provision unit 2 when products sold at a discount are referred to by the purchaser. When the purchaser selects a product, by referring to the product master 7 using the product code of the selected product, the product information and price provision unit 2 obtains product information corresponding to the selected product and sets the obtained product information on the product information and price provision screen (step S20). Next, the product information and price provision unit 2 sets a current selling price (and a discount price transition table) on the screen, based on a selling price (and a discount price transition) set by the selling price setting unit 2 (step S21). In the setting, a “Purchase” button indicating immediate purchase may be provided in a field corresponding to a current selling price, and a “Reserve” button indicating reserved purchase may be provided in a field corresponding to a date after a current date in the discount price transition table. The processing of setting a selling price (and a discount price) by the selling price setting unit 2 will be described later.

The product information and price provision unit 2 displays the set screen in the screen of the purchaser's terminal TA (step S22), and waits for entry from the purchaser (step S23). When the purchaser specifies immediate purchase at a current price (step S24: Yes), control goes to the processing of immediate purchase at a current price (step S25) and the processing terminates.

When the purchaser specifies reserved purchase (step S26: Yes) without specifying immediate purchase at a current price (step S24: No), control goes to the processing of reserved purchase at a specified reservation date (step S27) and the processing terminates. When other processing is specified (step S26: No), specified processing is performed and the processing terminates.

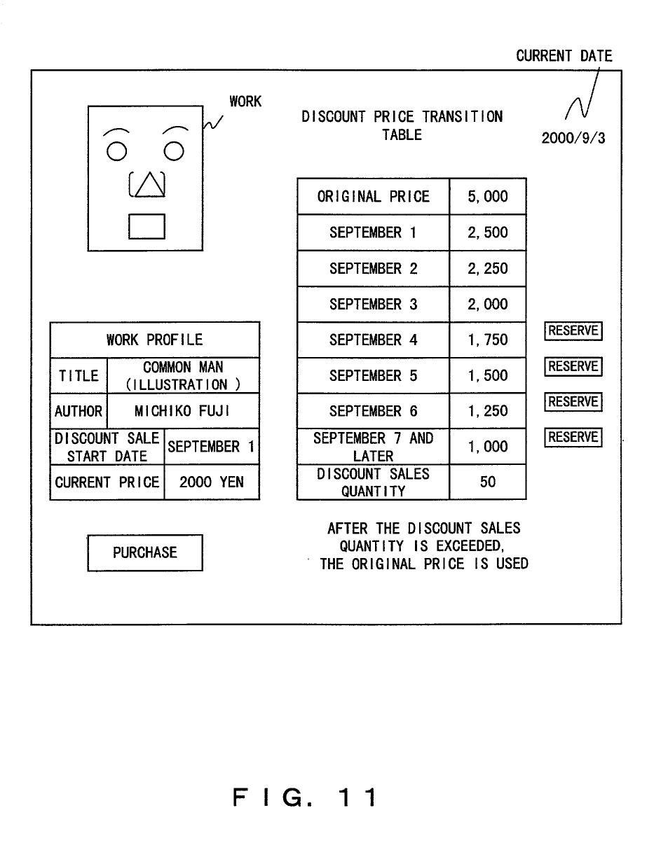

FIG. 11 shows an example of a product information and price provision screen. In FIG. 11, based on the obtained product information, the image of the product (work) is displayed at the upper left portion of the screen, and the title, author, sale start date, and current price of the work are displayed at the lower left portion. A “Purchase” button is displayed at the left bottom. When the “Purchase” button is pressed, immediate purchase processing is performed.

A current date “2000/9/3” is displayed at the upper right corner of the screen, and a discount price transition table after discount sale is started is displayed at the right of the screen. A price at Sep. 3, 2000 in the discount price transition table is 2000 yen, which is equal to “Current price” displayed at the lower left portion of the screen. “Reserve” buttons are displayed at the right of prices at and after September 4. When a “Reserve” button is pressed, that day is regarded as a reservation date and reserved purchase processing is performed.

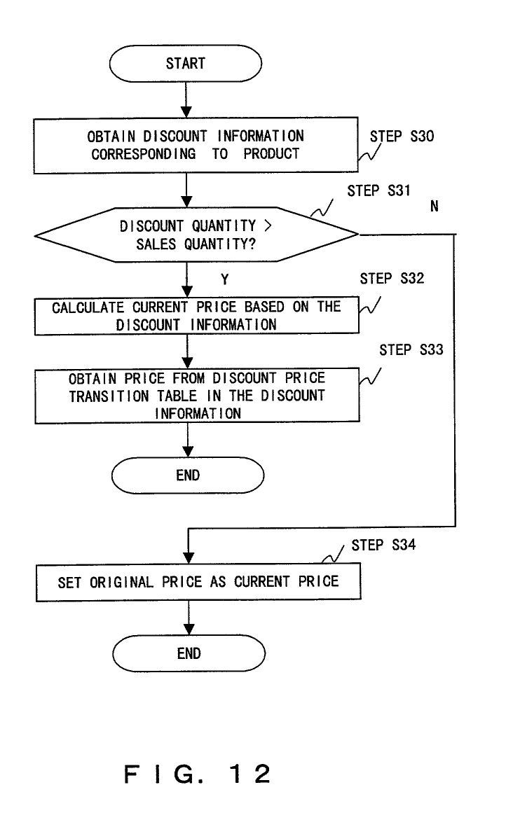

Next, using FIG. 12, a description will be made of the selling price setting process performed by the selling price setting unit 2. This process is performed in step S21 in FIG. 10. First, by referring to the discount rate table 6 using a product code of the product selected by the purchaser, the selling price setting unit 2 obtains discount information corresponding to the selected product (step S30). The selling price setting unit 2 compares a discount quantity and a sales quantity contained in the obtained discount rate information (step S31). If the discount quantity is greater than the sales quantity (step S31: Yes), since discount sale can still continue, a current price is set based on the discount information (step S32). If a discount price transition table is contained in the discount information, the information of the discount price transition table is also obtained (step S33), and the processing terminates. In the example of FIG. 2, the discount price transition table corresponds to the information of item Nos. 3-2 and 3-3 in the discount information. If the discount quantity is equal to or less than the sales quantity (step S31: No), since discount sale has terminated, a current selling price is set to an original price and the processing terminates. In this case, the discount price transition table is not displayed on the product information and price provision screen (step S34).

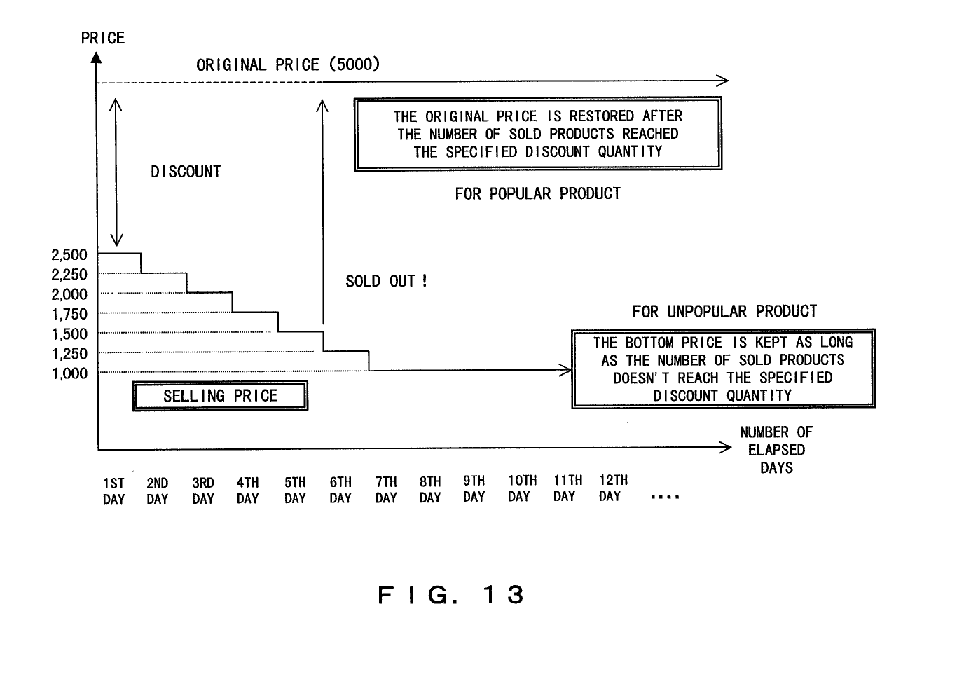

FIG. 13 shows a selling price set based on the discount rate table 6 shown in FIG. 2, that is, the discount information shown in FIG. 9. In FIG. 13, a horizontal axis denotes the number of elapsed days after discount sale is started, and a vertical axis denotes the price of a product. A discount price starts from 2500 yen, which is a discount rate 50% or half of the original price 5000 yen, and lower by 5% every day or 250 yen, based on the discount price transition table contained in the discount rate table 6 shown in FIG. 2. If the sales quantity (the number of sold products) is equal to or greater than the discount quantity until the selling price reaches a bottom price, the discount sale is terminated and the selling price returns to the original price. If the sales quantity is less than the discount quantity when the selling price reaches the bottom price, the bottom price is kept as the selling price until the number of sold products reaches the discount quantity.

The seller can have the advantages described below by carrying out discount sale in this system.

Since the discount sale can achieve more sales quantity than usual, an increase in publicity and popularity is expected.

By setting a selling price to an original price after a discount quantity of the product is sold, it becomes easy to compensate for a loss resulting from the discount sale.

By changing selling prices depending on time, it becomes possible to determine a saleable price even if a discount quantity is not achieved.

The purchaser has the advantages described below.

Seeing a provided selling price transition, the purchaser can wait for purchase until a discount price reaches a desired purchase price.

The purchaser can make reservation for purchase at a date at which a discount price reaches a desired purchase price.

Since the discount sale management apparatus 10 is provided between an order receipt processing system and the purchaser, an administrator of this system also has the advantage that he can introduce this system while using an existing order receipt system.

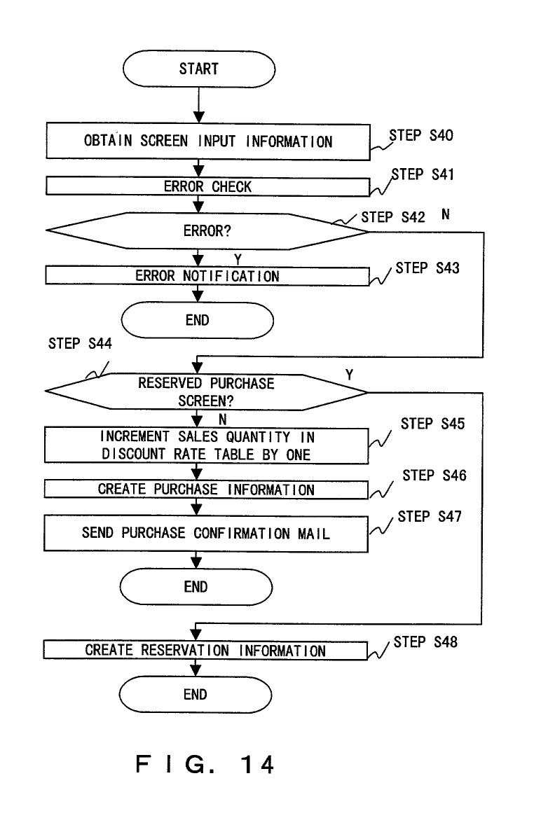

Hereinafter, using FIG. 14, a description will be made of processing performed by the order receipt unit 3 when an order is received from the purchaser who is presented with product and price information. In the product information and price provision screen shown in FIG. 11, immediate purchase and reserved purchase can be accepted. When the purchaser specifies immediate purchase or reserved purchase, the order receipt unit 3 outputs the purchase screen to the purchaser's terminal TA (not shown) and obtains information entered from the purchaser according to instructions from the screen (step S40). Items of the information are the same as those of information stored in the reservation file 8 or the purchase information file 9.

The order receipt unit 3 performs error checking to see if the obtained information is correct and necessary information is omitted (step S41). If an error is found (step S42: Yes), the occurrence of the error is reported to the purchaser (step S43) and the processing terminates. If no error is found (step S42: No), the order receipt unit 3 judges whether the received order is for immediate purchase or reserved purchase (step S44). This setting can be made based on from which bottom on the screen the obtained information was entered.

For an immediate purchase order (step S44: No), the order receipt unit 3 obtains discount information corresponding to an ordered product by referring to the discount rate table 6 using a product code contained in the obtained information, and increments by one a sales quantity contained in the discount information (step S45). Next, the order receipt unit 3 creates purchase information based on the obtained information and stores it in the purchase information file 9 (step S46). The order receipt unit 3 instructs the purchaser to confirm the contents of the purchase (step S47) and terminates the processing. The confirmation may be made using, e.g., an electronic mail address, telephone number, contained in the purchase information.

If the received order is reserved purchase (step S44: Yes), the order receipt unit 3 creates reservation information based on the obtained information, stores it in the reservation file 8 (step S48), and terminates the processing.

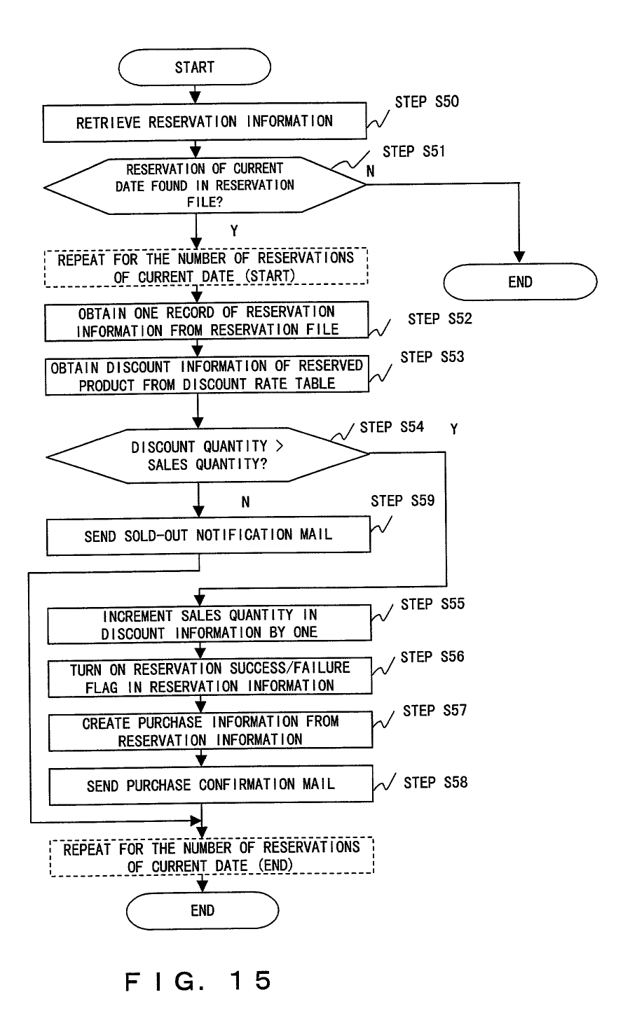

For reserved purchase, at a reservation date, reservation is allocated to the product. Hereinafter, using FIG. 15, a description will be made of the processing of allocating reservation to a product. At a fixed time every day, e.g., at 0 o'clock, the reservation allocation processing unit 5 refers to the reservation file 8 to retrieve the reservation information that a current date is a reservation date (step S50). If no relevant reservation information is found as a result of the retrieval (step S51: No), the reservation allocation processing unit 5 terminates the processing.

If relevant reservation information is found (step S51: Yes), processing from steps S52 to S59 is repeated the number of times equal to the number of pieces of obtained reservation information (steps between two rectangles indicated by dashed lines). First, the reservation allocation processing unit 5 obtains one piece of reservation information that a current date is a reservation date, from the reservation file 8 (step S52). The reservation allocation processing unit 5 uses a product code contained in the reservation information to obtain discount information corresponding to the reserved product from the discount rate table 6 (step S53).

The reservation allocation processing unit 5 compares a discount quantity and a sales quantity contained in the discount information (step S54) If the discount quantity is greater than the sales quantity, the reservation allocation processing unit 5 increments by one sale result information contained in the discount information corresponding to the reserved product (step S55). Next, the reservation allocation processing unit 5 turns on a flag indicating reservation success/failure contained in the reservation information corresponding to the reserved product, stored in the reservation file 8 (step S56). This indicates that a purchase has been established. Furthermore, the reservation allocation processing unit 5 creates purchase information, based on the reservation information corresponding to the reserved product, stores it in the purchase information file 9 (step S57), and prompts the purchaser to confirm the purchase (step S58).

If the discount quantity is equal to or less than the sales quantity (step S54: No), since discount sale cannot be carried out, the purchaser is notified that the discount quantity has sold out (step S59). The confirmation and notification may, as described above, be made using, e.g., an electronic mail address, telephone number, etc., contained in the reservation information.

In this way, after the processing from steps S52 to S59 is repeated the number of pieces of reservation information, the reservation allocation processing unit 5 terminates processing. Where plural pieces of reservation information exist for same products at same reservation dates and the products cannot be allocated to all the pieces of reservation information because the rest of discount quantity is small, allocation may be made on a first-come, first-served basis. In this case, since the reservation information is created, in principle, in the order of receipt, the order of reservation can be known based on order receipt dates contained in the reservation information.

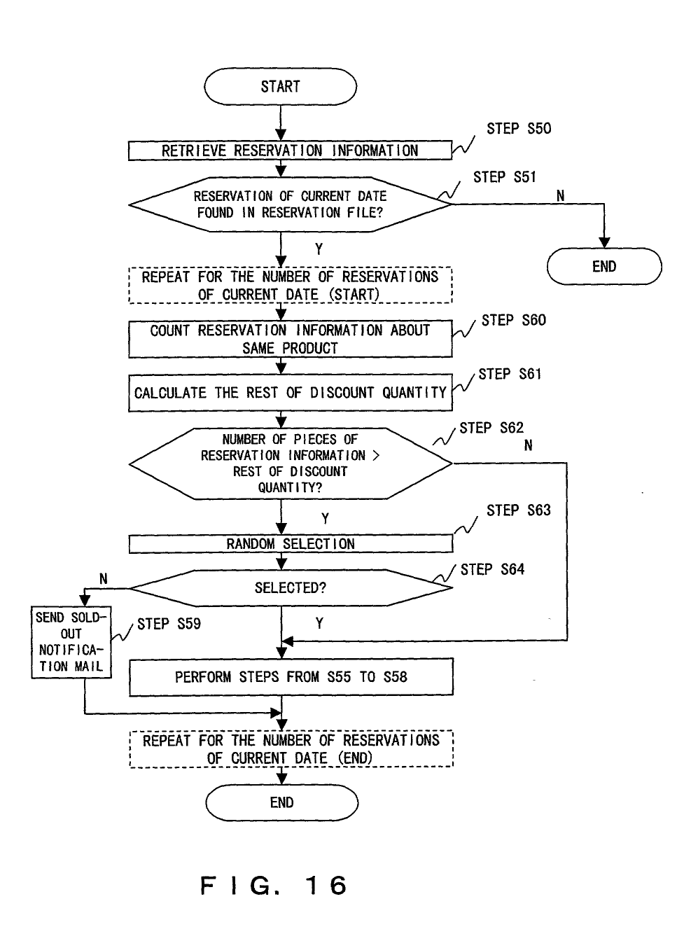

In such a case, allocation may also be made on a random selection basis. Hereinafter, allocation on a random selection basis will be described using FIG. 16. A description of the same processing in FIG. 15 is omitted.

After steps S51 and S52 of FIG. 15, the reservation allocation processing unit 5 based on a product code contained in the reservation information counts the number of pieces of reservation information on the same product (step S60). Next, the reservation allocation processing unit 5 obtains discount information corresponding to the reserved product from the discount rate table 6, subtracts a sales quantity from a discount quantity contained in the discount information to calculate the rest of discount quantity (step S61), and compares the number of pieces of reservation information and the rest of discount quantity (step S62). If the number of pieces of reservation information is equal to or less than the rest of discount quantity (step S62: No), processing from steps S55 to S58 of FIG. 15 is performed by the number of pieces of reservation information.

If the number of pieces of reservation information is greater than the rest of discount quantity (step S62: Yes), arbitrary reservation information is selected by the rest of discount quantity, that is, random selection is made (step S63). For selected reservation information (step S64: Yes), processing from steps S55 to S58 of FIG. 15 is performed, and for reservation information not selected (step S64: No), step S59 of FIG. 15 is performed.

For reserved purchase, if a sales quantity becomes equal to or greater than a discount quantity until a reservation date is reached, the product cannot be purchased at a desired price when the reservation date is reached. This means that public evaluation for the product is higher than the purchaser thinks, and purchaser's recognition, that is, price setting, is too low. However, even in this case, the purchaser can purchase the product at the original price.

This system provides purchasers with the following incentives to purchase.

A product can be obtained cheaply by purchasing it until a discount quantity of products have sold out.

Where a discount price lowers relative to time, a product can be obtained more cheaply by prolonging purchase timing. However, too prolonged purchase timing results in a discount quantity of products being sold out and a selling price returning to an original price. Accordingly, more sales promotion can be achieved in comparison with mere discount sale.

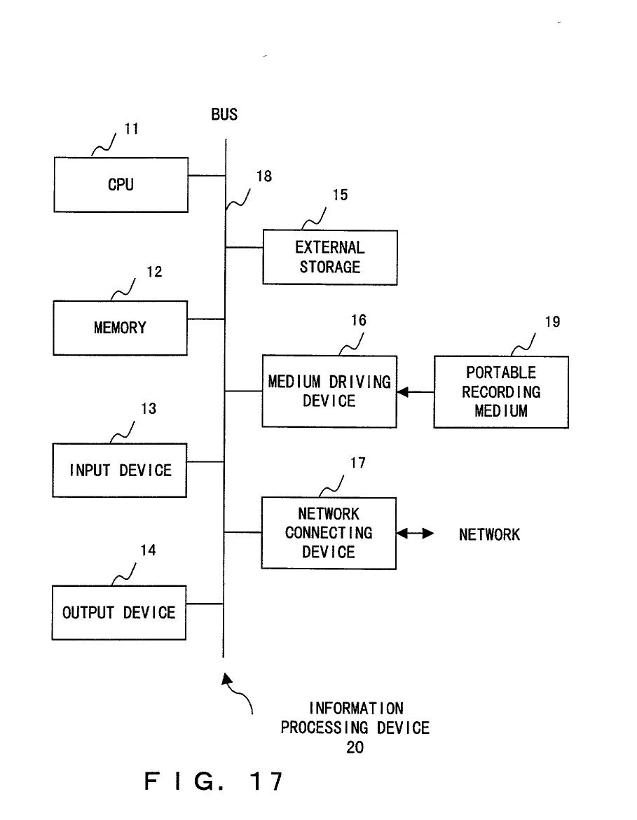

The terminals TA and TB, and the discount sale management apparatus 10 described in the embodiment can be configured using an information processing unit (computer) as shown in FIG. 17. An information processing device 20 of FIG. 17 comprise CPU 11, memory 12, an input device 13, an output device 14, an external storage 15, a medium driving device 16, and a network connecting device 17, which are connected with each other through a bus 18.

The memory 12 includes, e.g., ROM (Read Only Memory), RAM (Random Access Memory) to store programs and data used for processing. The CPU 11 performs necessary processing by executing a program using the memory 12.

Units making up the discount sale management apparatus 10, and the terminals TA and TB concerned in the embodiment are stored in specific program code segments of the respective memory 12. The input device 13 is, e.g., a keyboard, pointing device, touch panel, and is used to input instructions and information from users. The output device 14 is, e.g., a display, printer, and is used for inquiries to users of the information processing device 20 and output of processing results.

The external storage 15 is, e.g., a magnetic disk unit, optical disk unit, magnet-optical disk unit. The above described programs and data are stored in the external storage 15, and can be loaded into the memory 12 for use as required.

The medium driving device 16 drives a portable recording medium 19 and gains access to its recording contents. As the portable recording medium 19, there are used any computer-readable recording media, such as a memory card, memory stick, floppy disk, CD-ROM (Compact Disc Read Only Memory), optical disk, magneto-optical disk, DVD (Digital Versatile Disk). The above described programs and data are stored in the portable recording medium 19, and can be loaded into the memory 12 for use as required.

The network connecting device 17 communicates with external apparatuses over a network N (line) such as LAN, WAN, and performs data conversion accompanying communications. As required, the above described programs and data are received from an external apparatus and can be loaded into the memory 12 for use.

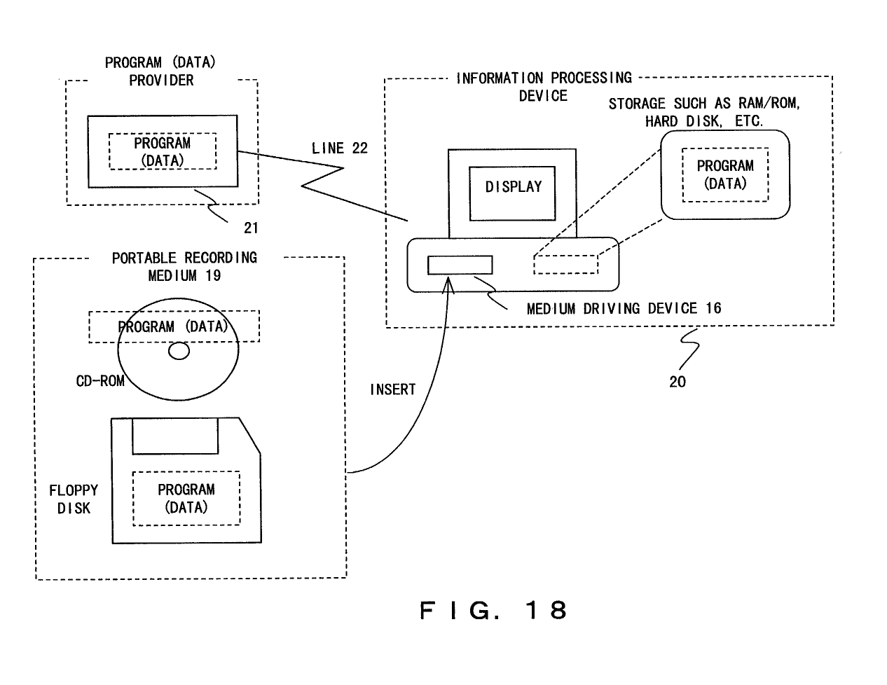

FIG. 18 shows computer-readable recording media and transmission signals through which programs and data can be supplied to the information processing unit of FIG. 17. It is also possible to have a general purpose computer perform a function corresponding to the discount sale management apparatus 10 described in the above described embodiment. To do this, the computer may be configured as described below. That is, programs for having the computer perform the same processing performed by the discount sale management apparatus 10 in the flowcharts shown in FIGS. 8, 10, 12, 14 to 16 described in the embodiment are stored in advance in the computer-readable recording medium 19, the programs are read into the computer 20 from the recording medium 19 so that they are temporarily stored in the memory 12 and external storage 15 of the computer 20 as shown in FIG. 18, and the stored programs are read by the CPU 11 of the computer 20 for execution.

Transmission signals themselves transmitted over the line 22 when the programs are down-loaded into the computer 20 from a database 21 of a program (data) provider also make it possible to have the general purpose computer perform the function corresponding to the discount sale management apparatus 10 described in the above described embodiment of the present invention.

Although the embodiment of the present invention has been described above, the present invention is not limited to the above described embodiment and allows other various variations. For example, the discount sale management apparatus 10 may further include a purchase result provision unit that edits sale result quantities by selling price, based on purchase information, and provides the editing result to a purchaser or seller. The purchase result provision unit may provide the rest of discount quantity as well. This enables the purchaser and the seller to know at what price the product is best salable. Thereby, the purchaser can refer to information presented when setting a price and timing for immediate purchase or reserved purchase of the product, and the seller can also refer to it when setting a selling price in future.

Although the example of lowering a discount price with time was described, the discount price may be increased with time. This is considered to be effective for sale promotion of relatively salable products.

Although it was exemplified that a purchaser is always presented with selling prices based on the latest sales quantity and can make immediate purchase at a presented current price. Instead of accepting an immediate purchase order, the same price may be displayed for a given period of time, e.g., 24 hours, all purchase orders accepted throughout the given period may be treated as reserved purchase, and the product may be allocated to the reserved purchase after the period has elapsed. In this case, the sales quantity is updated after the allocation processing, and based on it, the selling price setting unit may set a new selling price. The reservation allocation processing may be performed as described using FIGS. 15 and 16.

Units and DBs making up the discount sale management apparatus 10 operate in conjunction with each other and thereby achieve a series of business processes. These units and DBs may be provided in the same server or different servers so that they operate in conjunction with each other over a network.

As has been described above in detail, according to the present invention, discount sale can be managed to perform sale in line with the speculation of both purchasers and sellers.

While the invention has been described with reference to the preferred embodiments thereof, various modifications and changes may be made to those skilled in the art without deuniting from the true spirit and scope of the invention as defined by the claims thereof.

What is claimed is:

1. A discount sale management method of managing a selling price, comprising:
counting a sales quantity;
setting a discount price as the selling price, the discount price produced by a discount from an original price, while the sales quantity is less than a predetermined quantity; and
setting the original price as the selling price at the time the sales quantity becomes equal to or greater than the predetermined quantity.

2. The discount sale management method according to claim 1, further comprising:
changing the discount price relative to time.

3. The discount sale management method according to claim 2, further comprising:
lowering the discount price with the passage of time.

4. The discount sale management method according to claim 3, further comprising:
setting the discount price to a minimum discount price; and
holding the minimum discount price as the selling price after the selling price reaches the minimum discount price, as long as the sales quantity is less than the predetermined quantity.

5. The discount sale management method according to claim 3, further comprising:
providing a schedule of change of the discount price; and
accepting, from a purchaser, a purchase reservation specifying a desired purchase price, a purchase reservation time of the purchase reservation is set when the selling price reaches the desired purchase price.

6. The discount sale management method according to claim 5, further comprising:
allocating a product to the purchase reservation if the sales quantity is less than the predetermined quantity when the selling price reaches the desired purchase price.

7. The discount sale management method according to claim 5, further comprising:
canceling the purchase reservation if the sales quantity is equal to or greater than the predetermined quantity when the selling price reaches the desired purchase price.

8. A method of purchasing a product sold at a discount, comprising:
making a purchase reservation specifying a desired purchase price, a time when a selling price reaches the desired purchase price is a reservation sales time; and
receiving allocation of the product, if a predetermined quantity of the product has not been sold out when the reservation sales time is reached.

9. A computer-readable recording medium in which a programs for instructing a computer to control selling price management is recorded, the program instructs the computer to perform the process of:
counting a sales quantity;
setting a discount price as a selling price, a discount price produced by a discount from an original price, while the sales quantity is less than a predetermined quantity; and
setting the original price as the selling price, after the sales quantity becomes equal to or greater than the predetermined quantity.

10. A discount sale management apparatus that manages a selling price, comprising:
a selling price setting unit counting a sales quantity, setting a discount price produced by a discount from an original price as the selling price, while the sales quantity is less than a predetermined quantity, and setting the original price as the selling price after the sales quantity becomes equal to or greater than the predetermined quantity; and
a price provision unit providing the set selling price.

11. Computer data signals embodied into transmission signals, for instructing a computer to control selling price management, the program instructing the computer to perform the process of:
counting a sales quantity;
setting a discount price produced by a discount from an original price as a selling price, while the sales quantity is less than a predetermined quantity; and
setting the original price as the selling price, after the sales quantity becomes equal to or greater than the predetermined quantity.
